(19) United States
(12) Patent Application Publication
(10) Pub. No.: US 2020/0218916 A1
(43) Pub. Date: Jul. 9, 2020

(54) METHOD AND APPARATUS FOR ANTI-SPOOFING DETECTION, AND STORAGE MEDIUM

(71) Applicant: BEIJING SENSETIME TECHNOLOGY DEVELOPMENT CO., LTD., Beijing (CN)

(72) Inventors: Liwei WU, Beijing (CN); Rui ZHANG, Beijing (CN); Junjie YAN, Beijing (CN); Yigang PENG, Beijing (CN)

(21) Appl. No.: 16/826,515

(22) Filed: Mar. 23, 2020

Related U.S. Application Data
(63) Continuation of application No. PCT/CN2019/089493, filed on May 31, 2019.

(30) Foreign Application Priority Data
Sep. 7, 2018 (CN) 201811044838.5

(51) Int. Cl. G06K 9/00; G06K 9/62; G10L 15/25; G10L 15/16

(52) U.S. Cl. CPC G06K 9/00899; G06K 9/00335; G10L 15/16; G06K 9/6288; G10L 15/25; G06K 9/00315

(57) ABSTRACT

A method for anti-spoofing detection includes: obtaining at least one image subsequence from an image sequence, where the image sequence is acquired by an image acquisition apparatus after prompting a user to read a specified content, and the image subsequence includes at least one image in the image sequence; performing lipreading on the at least one image subsequence to obtain a lipreading result of the at least one image subsequence; and determining an anti-spoofing detection result based on the lipreading result of the at least one image subsequence.

### CROSS-REFERENCE TO RELATED APPLICATIONS

The present disclosure is a continuation of International Patent Application No. PCT/CN2019/089493, filed on May 31, 2019, which claims priority to Chinese Patent Application No. CN201811044838.5, filed on Sep. 7, 2018. The disclosures of International Patent Application No. PCT/CN2019/089493 and Chinese Patent Application No. CN201811044838.5 are hereby incorporated by reference in their entireties.

### BACKGROUND

As an effective identity authentication and recognition technology, the face recognition technologies have been widely used at present due to its convenience for use, user-friendliness, non-contact and other characteristics, such as intelligent video, security monitoring, mobile device unlocking, access control gate unlocking, face payment and the like. With the rapid development of deep learning technologies, the accuracy of face recognition has been able to exceed the accuracy of fingerprint recognition. However, compared with other biometric information such as fingerprints, face data is easier to be obtained, and the face recognition system is also vulnerable to attacks of some illegal users. How to improve the security of face recognition has become a widely concern issue in the present field.

### SUMMARY

The present disclosure relates to the field of computer vision technologies, and in particular, to a method and apparatus for anti-spoofing detection, and a storage medium.

Embodiments of the present disclosure provide a technical solution for anti-spoofing detection.

According to one aspect of the embodiments of the present disclosure, provided is a method for anti-spoofing detection, including: obtaining at least one image subsequence from an image sequence, where the image sequence is acquired by an image acquisition apparatus after prompting a user to read a specified content, and the image subsequence includes at least one image in the image sequence; performing lipreading on the at least one image subsequence to obtain a lipreading result of the at least one image subsequence; and determining an anti-spoofing detection result based on the lipreading result of the at least one image subsequence.

According to another aspect of the embodiments of the present disclosure, provided is an apparatus for anti-spoofing detection, including: a processor; and a memory, configured to store instructions executable by the processor, wherein the processor is configured to implement the operations of the method as described above.

According to yet another aspect of the embodiments of the present disclosure, provided is a computer-readable storage medium having stored thereon computer programs that, when being executed by a processor, causes the processor to implement the method for anti-spoofing detection as described above.

The following further describes in detail the technical solutions of the present disclosure with reference to the accompanying drawings and embodiments.

### BRIEF DESCRIPTION OF THE DRAWINGS

The accompanying drawings constituting a part of the specification describe the embodiments of the present disclosure and are intended to explain the principles of the present disclosure together with the descriptions. According to the following detailed descriptions, the present disclosure may be understood more clearly with reference to the accompanying drawings.

FIG. 1 is a schematic flowchart of a method for anti-spoofing detection according to the embodiments of the present disclosure.

FIG. 2 is another schematic flowchart of the method for anti-spoofing detection according to the embodiments of the present disclosure.

FIG. 3 is a schematic diagram of a confusion matrix and an application example thereof according to the embodiments of this disclosure.

FIG. 4 is another schematic flowchart of the method for anti-spoofing detection according to the embodiments of the present disclosure.

FIG. 5 is a block diagram of an apparatus for anti-spoofing detection according to the embodiments of the present disclosure.

FIG. 6 is a schematic structural diagram of one application embodiment of an electronic device of the present disclosure.

### DETAILED DESCRIPTION

Various exemplary embodiments of the present disclosure are now described in detail with reference to the accompanying drawings. It should be noted that, unless otherwise stated specifically, relative arrangement of the components and steps, the numerical expressions, and the values set forth in the embodiments are not intended to limit the scope of the present disclosure.

The following descriptions of at least one exemplary embodiment are merely illustrative actually, and are not intended to limit the present disclosure and the applications or uses thereof. Technologies, methods and devices known to a person skilled in the related art may not be discussed in detail, but such technologies, methods and devices should be considered as a part of the specification in appropriate situations. It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to electronic devices such as terminal devices, computer systems, servers, which may operate with numerous other general-purpose or special-purpose computing system environments or configurations. Examples of well-known computing systems, environments, and/or configurations suitable for use together with the computer systems/servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems.

The electronic devices such as terminal devices, computer systems, and servers may be described in the general context of computer system executable instructions (for example, program modules) executed by the computer system. Generally, the program modules may include routines, programs, target programs, components, logics, data structures, and the like for performing specific tasks or implementing specific abstract data types. The computer systems/servers may be practiced in the distributed cloud computing environments in which tasks are executed by remote processing devices that are linked through a communications network. In the distributed computing environments, the program modules may be located in local or remote computing system storage media including storage devices.

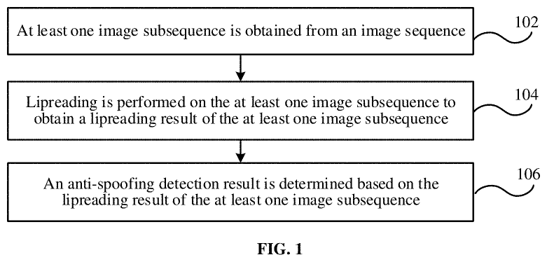

FIG. 1 is a schematic flowchart of a method for anti-spoofing detection according to the embodiments of the present disclosure.

At 102, at least one image subsequence is obtained from an image sequence.

The image sequence is acquired by an image acquisition apparatus after prompting a user to read a specified content, and each image subsequence includes at least one image in the image sequence.

The image sequence may come from a video that is captured after prompting the user to read the specified content. In the embodiments of the present disclosure, the image sequence may be obtained in various manners. In one example, the image sequence may be obtained via one or more cameras, and in another example, the image sequence may be obtained from other devices, for example, a server receives the image sequence sent by a terminal device or a camera, and the like. The manner in which the image sequence is obtained is not limited in the embodiments of the present disclosure.

In some optional examples, the specified content is content that the user is required to read aloud based on the purpose of anti-spoofing detection, and the specified content may include at least one character, where the character may be a letter, a Chinese character, a number or a word. For example, the specified content may include any one or more numbers from 0 to 9, or include any one or more letters in from A to Z, or include any one or more of a plurality of predetermined Chinese characters, or include any one or more of the plurality of predetermined words, or may be any combination of at least two of the numbers, letters, words, and Chinese characters, which is not limited in the embodiments of the present disclosure. In addition, the above-mentioned specified content may be specified content generated in real-time, for example, may be randomly generated, or the specified content may be preset fixed content, which is not limited in the embodiments of the present disclosure.

According to one or more embodiments of the disclosure, the image sequence may be divided into at least one image subsequence. For example, multiple images included in the image sequence may be divided into at least one image subsequence according to the sequential relationship. Each image subsequence includes at least one consecutive image, but the manner in which the image subsequence is divided is not limited in the embodiments of the present disclosure. Alternatively, the at least one image subsequence is only a part of the image sequence and the remaining part is not used for anti-spoofing detection, which is not limited in the embodiments of the present disclosure.

According to one or more embodiments of the disclosure, each image subsequence in the abovementioned at least one image subsequence corresponds to one character read/said by the user, and accordingly, the number of the at least one image subsequence may be equal to the number of characters read/said by the user.

According to one or more embodiments of the disclosure, the characters in the above specified content may, for example, include, but are not limited to, any one or more of: numbers, English letters, English words, Chinese characters, symbols, etc. According to one or more embodiments of the disclosure, if the characters in the specified content are English words or Chinese characters, a dictionary including these English words or Chinese characters may be defined in advance, and the dictionary includes the English words or Chinese characters, as well as number information corresponding to each of the English words or Chinese characters.

According to one or more embodiments of the disclosure, in some embodiments, the specified content may be randomly generated before 102, or the specified content may be generated in other predetermined manners. In this way, by generating the specified content in real time, it is possible to prevent the user from knowing the specified content in advance and performing targeted spoofing, thereby further improving the reliability of the anti-spoofing detection.

According to one or more embodiments of the disclosure, in some embodiments, prompt information may be sent before 102 to prompt the user to read the specified content. The prompt may be audio, text, animation or the like, or any combination thereof, which is not limited in the embodiments of the present disclosure.

At 104, lipreading is performed on the at least one image subsequence to obtain a lipreading result of the at least one image subsequence.

In some embodiments, lipreading may be performed on each image subsequence of the at least one image subsequence to obtain the lipreading result of the each image subsequence.

At 106, an anti-spoofing detection result is determined based on the lipreading result of the at least one image subsequence.

That is, it is possible to determine whether the content read-out by the user is consistent with the specified content based on the lipreading result, and to determine whether the behavior of the user of reading-out the specified content is spoofed based on the result of the determination.

A face is unique biological characteristics of each person. Compared with the traditional verification modes such as password, face-based identity authentication has higher security. However, since the static face still has the possibility of being spoofed, there is still a certain security hole in the silent anti-spoofing detection based on the static face. Therefore, a more secure and effective anti-spoofing detection mechanism is needed for anti-spoofing detection of faces.

Based on the method for anti-spoofing detection provided in the foregoing embodiments of the present disclosure, at least one image subsequence is obtained from an image sequence; lipreading is performed on the at least one image subsequence to obtain a lipreading result of the at least one image subsequence; and an anti-spoofing detection result is determined based on the lipreading result of the at least one image subsequence. According to the embodiments of the present disclosure, at least one image subsequence is obtained from the image sequence, and lipreading is performed by analyzing the at least one image subsequence, and anti-spoofing detection is implemented based on the lipreading result of the at least one image subsequence. Therefore, the interaction is simple, and the reliability of anti-spoofing detection is improved.

In some embodiments, the method for anti-spoofing detection may further include: obtaining the audio corresponding to the image sequence; and segmenting the audio to obtain at least one audio segment. In this way, the audio is segmented to obtain a segmentation result of the audio. The segmentation result of the audio may include at least one audio segment, and each audio segment corresponds to one or more characters, where the characters herein may be of any type, such as, for example, a number, a letter, a character, or other symbols.

Specifically, the audio data of the user about reading the specified content may be obtained. The audio corresponding to the image sequence may be segmented into at least one audio segment corresponding to at least one character included in the specified content, and the at least one audio segment may be used as the segmentation result of the audio. In this way, the segmentation result of the audio includes an audio segment corresponding to each of the at least one character included in the specified content.

In some embodiments, each of the at least one audio segment corresponds to one character in the specified content. However, no limitation is made thereto in the embodiments of the present disclosure.

In some embodiments of the method shown in FIG. 1, operation 102 includes: obtaining the at least one image subsequence from the image sequence according to the segmentation result of the audio corresponding to the image sequence.

In this way, based on the segmentation result of the audio, the image sequence is segmented such that each of the obtained image subsequences corresponds to one or more characters.

In some optional examples, the step of obtaining the at least one image subsequence from the image sequence according to the segmentation result of the audio corresponding to the image sequence includes: obtaining the image subsequence corresponding to each character from the image sequence according to time information of the audio segment corresponding to the each character in the specified content.

The time information of the audio segment may include, but is not limited to, any one or more of: the duration of the audio segment, the start time of the audio segment, the end time of the audio segment, and the like. For example, the images in the image sequence that are within the time period corresponding to a certain audio segment are divided into one image subsequence, so that the image subsequence and the audio segment correspond to the same one or more characters.

In the embodiments of the present disclosure, the at least one image subsequence is obtained from the image sequence according to the segmentation result of the audio, and the number of the at least one image subsequence is less than or equal to the number of the characters included in the specified content. In some embodiments, the number of the at least one image subsequence is equal to the number of the characters included in the specified content, and moreover, the at least one image subsequence corresponds one-to-one to the at least one character included in the specified content. Each image subsequence corresponds to one character in the specified content.

According to one or more embodiments of the disclosure, the characters in the above specified content may, for example, include, but are not limited to, any one or more of: numbers, English letters, English words, Chinese characters, symbols, etc. If the characters in the specified content are English words or Chinese characters, a dictionary including these English words or Chinese characters may be defined in advance, and the dictionary includes English words or Chinese characters, and number information corresponding to each English word or Chinese character.

After the at least one image subsequence is obtained, each of the at least one image subsequence may be processed to obtain the lipreading result of each image subsequence.

In some embodiments, at least two lip region images may be obtained from the image subsequence, and the lipreading result of the image subsequence is obtained by processing the at least two lip region images. The at least two lip region images may be captured from each of the images included in the image subsequence, or may be captured from some images included in the image subsequence, for example, at least two target images are selected from multiple images included in the image subsequence, and a lip region image is captured from each of the at least two target images, which is not limited in the embodiments of the present disclosure.

In some embodiments, feature extraction processing is performed on the at least two target images included in the image subsequence to obtain feature information of each target image for representing lip morphology of the each target image, and the lipreading result is obtained based on the feature information for representing the lip morphology of the at least two target images. The at least two target images may be all or some of the images in the image subsequence, which is not limited in the embodiments of the present disclosure.

In some embodiments, operation 104 may include: obtaining lip region images from at least two target images included in the image subsequence; and obtaining the lipreading result of the image subsequence based on the lip region images of the at least two target images.

For example, the at least two target images may be selected from the image subsequence, and the specific selection manner of the target images is not limited in the present disclosure. After the target images are determined, the lip region images may be obtained from the target images.

In some possible implementations, the obtaining of lip region images from at least two target images included in the image subsequence includes:

performing key point detection on the target images to obtain information of face key points, where the information of the face key points includes position information of lip key points; and

obtaining the lip region images from the target images based on the position information of the lip key points.

According to one or more embodiments of the present disclosure, the target images may be face region images or original images acquired, which is not limited in the embodiments of the present disclosure. In this case, key point detection may be directly performed on the target images to obtain the information of the face key points. Alternatively, face detection may be on the target images to obtain the face region images, and then key point detection may be performed on the face region images to obtain the information of the face key points. In some embodiments of the disclosure, key point detection may be performed on the target images via a neural network model (such as, a convolutional neural network model). The specific implementation manner of the key point detection is not limited in the embodiments of the present disclosure.

In the embodiments of the present disclosure, the face key points may include multiple key points, such as one or more of lip key points, eye key points, eyebrow key points, and face edge key points. The information of the face key points may include the position information of at least one of the multiple key points, for example, the information of the face key points includes the position information of the lip key points, or further includes other information. The specific implementation of the face key points and the specific implementation of the information of the face key points are not limited in the embodiments of the present disclosure.

In some possible implementations, the lip region image may be obtained from the target image based on the position information of the lip key points included in the face key points. Alternatively, in the case that the face key points do not include the lip key points, the predicted position of the lip region may be determined based on the position information of the at least one key point included in the face key points, and the lip region image is obtained from the target image based on the predicted position of the lip region. The specific implementation of obtaining the lip region image is not limited in the embodiments of the present disclosure. After the lip region images of the at least two target images are obtained, the lipreading result of the image subsequence may be obtained based on the lip region images of the at least two target images.

In some possible implementations, the lip region images of the at least two target images may be input to a first neural network model for recognition processing, and the lipreading result of the image subsequence is output.

For example, feature extraction processing may be performed on the lip region images through the first neural network model to obtain lip morphology features of the lip region images, and the lipreading result is determined according to the lip morphological features. In some embodiments of the disclosure, the lip region image of each of the at least two target images may be input to the first neural network model for processing to obtain the lipreading result of the image subsequence, and the first neural network model outputs the lipreading result of the image subsequence. In one example, at least one classification result may be determined via the first neural network model based on the lip morphology features, and the lipreading result is determined based on the at least one classification result. The classification result, for example, may include the probability of classifying to each of multiple predetermined characters, or include a character to which the image subsequence is finally classified, where the characters may be, such as, for example, numbers, letters, Chinese characters, English words, or other forms. The specific implementation of the lipreading result based on the lip morphology features is not limited in the embodiments of the present disclosure. The first neural network model may be, for example, a convolutional neural network model, and the type of the first neural network model is not limited in the present disclosure.

In some possible implementations, considering the angle problem of the face image, before obtaining the lip region images from the target images based on the position information of the lip key points, the method further includes:

performing alignment processing on the target images to obtain target images subjected to the alignment processing; and

determining, based on the alignment processing, position information of the lip key points in the target images subjected to the alignment processing.

Accordingly, the lip region images is obtained from the target images subjected to the alignment processing based on the position information of the lip key points in the target images subjected to the alignment processing.

That is, the position information of the face key points (for example, the lip key points) in the target images subjected to the alignment processing may be determined based on the alignment processing, and the lip region image is obtained from the target image subjected to the alignment processing based on the position information of the lip key points in the target image subjected to the alignment processing. In this way, by obtaining the lip region image from the target image subjected to the alignment processing, front lip region images may be obtained, and the accuracy of lipreading may be improved as compared with the lip region images having angles. The specific manner of the alignment processing is not limited in the present disclosure.

In some possible implementations, operation 104 includes: obtaining lip morphology information of the at least two target images included in the image subsequence; and obtaining the lipreading result of the image subsequence based on the lip morphology information of the at least two target images.

For example, the at least two target images may be some or all of the multiple images included in the image subsequence, and the lip morphology information of each of the at least two target images may be obtained. The lip morphology information of the target image includes the lip morphology feature, and the lip morphology information of the target image may be obtained in various manners. In one example, the target image may be processed through a machine learning algorithm to obtain the lip morphology features of the target image. For example, the target image is processed through a support vector machine model to obtain the lip morphology features of the target image.

In some possible implementations, after the lip morphology information of each of the at least two target images is obtained, the lip morphology information of the at least two target images of the image subsequence may be processed by using a neural network model, and the lipreading result of the image subsequence is output. In this base, according to some embodiments of the disclosure, at least part of the at least two target images may be input to the neural network model for processing, and the neural network model outputs the lipreading result of the image subsequence. Alternatively, the lip morphology information of the at least two target images may be processed in other manners, which is not limited in the embodiments of the present disclosure.

In some possible implementations, the obtaining of the lip morphology information of the at least two target images included in the image subsequence includes: determining the lip morphology information of each target image based on a lip region image obtained from each of the at least two target images.

For example, the lip region image may be obtained from each of the at least two target images. Face detection may be performed on each target image to obtain a face region; the face region image is extracted from each target image and size normalization processing is performed on the extracted face region image; and according to the relative position of the face region and the lip feature points in the face region image subjected to the size normalization, the lip region image is extracted from the face region image subjected to the size normalization, and the lip morphology information of each target image is further determined.

In some possible implementations, the determining of the lip morphology information of each target image based on a lip region image obtained from each of the at least two target images includes:

performing feature extraction processing on the lip region image to obtain a lip morphology feature of the lip region image.

For example, feature extraction processing may be performed on the lip region image through a neural network model (such as, a convolutional neural network model) to obtain the lip morphology feature of the lip region image. It should be understood that the lip morphology feature may alternatively be obtained in other manners. The manner of obtaining the lip morphology feature of the lip region image is not limited in the embodiments of the present disclosure.

In this way, the lipreading result of the image subsequence may be determined based on the lip morphology information of each of the at least two target images.

In some possible implementations, before the lipreading is performed on the at least one image subsequence to obtain the lipreading result of the at least one image subsequence in operation 104, the method according to the embodiments of the present disclosure may further include: selecting the at least two target images from the image subsequence. That is, some or all of the images selected from the multiple images included in the image subsequence are used as the target images, so as to perform lipreading on the selected at least two target images in the subsequent operations. The selection from the multiple images may be randomly performed, or performed according to indexes such as the definition of the images, and the specific selection manner of the target images is not limited in the present disclosure.

In some optional examples, the at least two target images may be selected from the image subsequence in the following manners: selecting a first image that satisfies a predetermined quality standard from the image subsequence; and determining the first image and at least one second image adjacent to the first image as the target images. That is, the quality standard of the image may be predetermined, so as to select the target images according to the predetermined quality standard. The predetermined quality standard may include, but is not limited to, any one or more of: the image includes a complete lip edge, the lip definition reaches a first condition, the light brightness of the image reaches a second condition, and the like. According to the image including the complete lip edge, the lip region image may be more easily obtained by segmentation; and according to the image of which the lip definition reaches the predetermined first condition and/or the light brightness reaches the predetermined second condition, the lip morphology feature may be more easily extracted. The present disclosure does not set limitations to the predetermined quality standard, and the selections of the first condition and the second condition.

In some possible implementations, the first image that satisfies the predetermined quality standard may be selected from the multiple images included in the image subsequence, and then at least one second image adjacent to the first image (such as, an adjacent video frame before or after the first image) is selected. The selected first image and the second image are used as the target images. By selecting the image that satisfies the quality standard and the image adjacent thereto, it is easier to extract the lip morphology features of the images; and by analyzing the difference between the lip morphology features of the adjacent images, a more accurate lipreading result may be obtained.

In some possible implementations, the at least two target images are some of the multiple images included in the image subsequence. In this case, the method may further include: selecting at least two target images from the multiple images included in the image subsequence.

In the embodiments of the present disclosure, frame selection may be performed in various manners. For example, in some of these embodiments, frame selection may be performed based on the image quality. In one example, the first image that satisfies the predetermined quality standard may be selected from the multiple images included in the image subsequence, and the first image and the at least one second image adjacent to the first image may be determined as the target images.

The predetermined quality standard may include, but is not limited to, one or more of the following: the image includes a complete lip edge, the lip definition reaches a first condition, the light brightness of the image reaches a second condition, and the like. Alternatively, the predetermined quality standard may also include quality indexes of other types. The specific implementation of the predetermined quality standard is not limited in the embodiments of the present disclosure.

In the embodiments of the present disclosure, it is also possible to perform frame selection based on other factors, or to perform frame selection by combining the image quality and other factors to obtain the first image in the multiple images, and the first image and the at least one second image adjacent to the first image are determined as the target images.

The number of the first images may be one or more. In this way, the lipreading result may be determined based on the lip morphology information of the first image and the at least one second image adjacent thereto, where the first image and the at least one second image adjacent thereto may be used as an image set. That is, at least one image set may be selected from the image subsequence, and the lipreading result of the image set is determined based on the lip morphology information of at least two images included in the image set, such as the character corresponding to the image set, or the probability that the image set corresponds to each of the multiple characters, or the like. In some embodiments of the disclosure, the lipreading result of the image subsequence may include the lipreading result of each of the at least one image set; alternatively, the lipreading result of the image subsequence may further be determined based on the lipreading result of each of the at least one image set. However, no limitation is made thereto in the embodiments of the present disclosure.

In the embodiments of the present disclosure, the second image may be before the first image or after the first image. In some possible implementations, the at least one second image may include at least one image that is before the first image and adjacent to the first image, and include at least one image that is after the first image and adjacent to the first image. Being before or after the first image refers to the sequential relationship between the second image and the first image in the image subsequence, and being adjacent indicates that the position interval between the second image and the first image in the image subsequence is not greater than a predetermined numerical value, for example, the second image and the first image are adjacent in position in the image subsequence. In this case, according to some embodiments of the disclosure, a predetermined number of second images adjacent to the first image are selected from the image subsequence, or the number of images by which the second image and the first image are spaced in the image subsequence is not greater than 10, but the embodiments of the present disclosure is not limited thereto.

According to one or more embodiments of the disclosure, during the selecting of the at least two target images from the multiple images included in the image subsequence, in addition to the aforementioned predetermined quality standard, the selection may be performed by further considering the following indexes: the lip morphology changes consecutively between the selected images. For example, in some optional examples, an image, that satisfies the predetermined quality standard and reflects an effective change in the lip morphology, and at least one frame image that is before and/or after the image that reflects the effective change in the lip morphology may be selected from the image subsequence. The width of a gap between the upper and lower lips may be used as a predetermined judgment criterion for the effective change in the lip morphology.

For example, in one application example, during the selection of the at least two target images from the multiple images included in the image subsequence, the selection criteria may be that the predetermined quality standard is satisfied, and the gap between the upper and lower lips have a maximum width. One frame image that satisfies the predetermined quality standard and has a maximum change in the lip morphology, and at least one frame image that is before and after this frame image are selected. In actual applications, if the specified content is at least one number from 0 to 9, the average reading time of each number is about 0.8 s, and the average frame rate is 25 fps. With this regard, five to eight frame images may be selected for each number as an image subsequence that reflects the effective change in the lip morphology, but which is not limited thereto in the embodiments of the present disclosure.

After the lipreading result of at least one image subsequence is obtained, in some possible implementations, in operation 106, it is possible to determine whether the lipreading result of the at least one image subsequence is consistent with the specified content, and to determine the anti-spoofing detection result based on the determination result. For example, in response to the lipreading result of the at least one image subsequence being consistent with the specified content, the anti-spoofing detection result is determined to be that the anti-spoofing detection passes or no spoofing exists. For another example, in response to the lipreading result of the at least one image subsequence being inconsistent with the specified content, the anti-spoofing detection result is determined to be that the anti-spoofing detection does pass or spoofing exists.

Alternatively, it is also possible to further obtain the audio of the user reading the above specified content, perform voice recognition processing on the audio to obtain the voice recognition result of the audio, and determine whether the voice recognition result of the audio is consistent with the specified content. In this case, according to some embodiments of the disclosure, if at least one of the voice recognition result of the audio and the lipreading result of the at least one image subsequence is inconsistent with the specified content, it is determined that the anti-spoofing detection does not pass. In some embodiments of the disclosure, if both the voice recognition result of the audio and the lipreading result of the at least one image subsequence are consistent with the specified content, it is determined that the anti-spoofing detection passes, but the embodiments of the present disclosure is not limited hereto.

In some possible implementations, the lipreading result of the corresponding image subsequence may be tagged according to the voice recognition result of each audio segment in the segmentation result of the audio, where the lipreading result of each image subsequence is tagged with the voice recognition result of the audio segment corresponding to the image subsequence, that is, the lipreading result of each image subsequence is tagged with the character corresponding to the image subsequence, and then the lipreading result of the at least one image subsequence tagged with the character is input to a second neural network model to obtain the matching result between the lipreading result of the image sequence and the voice recognition result of the audio.

In the embodiments of the present disclosure, the image sequence is correspondingly divided into at least one image subsequence according to the segmentation result of the audio, the lipreading result of each image subsequence is compared with the voice recognition result of each audio segment, and the anti-spoofing detection based on the lipreading is implemented according to whether the above two are matched.

In other embodiments, the determining of the anti-spoofing detection result based on the lipreading result of the at least one image subsequence in operation 106 includes:

fusing the lipreading result of the at least one image subsequence to obtain a fusion recognition result. For example, the lipreading result of the at least one image subsequence is fused based on the voice recognition result of the audio to obtain the fusion recognition result.

Whether the fusion recognition result matches the voice recognition result of the audio corresponding to the image sequence is determined. For example, the fusion recognition result and the voice recognition result may be input to the second neural network model for processing, to obtain the matching probability between the lipreading result and the voice recognition result; and whether the lipreading result matches the voice recognition result is determined based on the matching probability between the lipreading result and the voice recognition result.

The anti-spoofing detection result is determined based on the matching result between the fusion recognition result and the voice recognition result of the audio.

According to the matching result of whether the fusion recognition result matches the voice recognition result of the audio, if the fusion recognition result matches the voice recognition result, it is determined that the anti-spoofing detection passes, and a related operation for indicating the pass of the anti-spoofing detection may be further selectively executed. Otherwise, if the fusion recognition result does not match the voice recognition result, it is determined that the anti-spoofing detection does not pass, and a prompt message that the anti-spoofing detection does not pass may be further selectively output.

For example, to obtain the voice recognition result of the audio corresponding to the image sequence, it may be determined whether the fusion recognition result matches the voice recognition result of the audio, and the anti-spoofing detection result is determined according to the matching result of whether the fusion recognition result matches the voice recognition result of the audio. For example, in response to the fusion recognition result matching the voice recognition result, it is determined that the user passes the anti-spoofing detection. For another example, in response to the fusion recognition result not matching the voice recognition result, it is determined that the user does not pass the anti-spoofing detection.

According to one or more embodiments of the disclosure, the lipreading result of the image subsequence may, for example, include one or more characters corresponding to the image subsequence; alternatively, the lipreading result of the image subsequence includes: a probability that the image subsequence is classified into each of multiple predetermined characters corresponding to the specified content. For example, if the possible character set in the predetermined specified content includes the numbers from 0 to 9, then the lipreading result of each image subsequence includes: probabilities that the image subsequence is classified into each predetermined character from 0 to 9, but the embodiments of the present disclosure is not limited hereto.

In some possible implementations, the step of fusing the lipreading result of the at least one image subsequence to obtain a fusion recognition result includes: fusing the lipreading result of the at least one image subsequence, based on the voice recognition result of the audio corresponding to the image sequence, to obtain the fusion recognition result.

For example, the lipreading result of the at least one image subsequence may be fused based on the voice recognition result of the audio corresponding to the image sequence. For example, a feature vector corresponding to the lipreading result of each of the at least one image subsequence is determined, and at least one feature vector corresponding to the at least one image subsequence is concatenated based on the voice recognition result of the audio to obtain a concatenating result (a fusion recognition result).

Accordingly, in a further optional example, the lipreading result of the image subsequence includes the probability that the image subsequence is classified into each of the multiple predetermined characters. The predetermined character may be a character in the specified content, for example, in the case that the predetermined character is a number, the lipreading result includes the probabilities that the image subsequence is classified into each number from 0 to 9.

According to one or more embodiments of the disclosure, the step of fusing, based on the voice recognition result of the audio corresponding to the image sequence, the lipreading result of the at least one image subsequence to obtain the fusion recognition result includes:

sorting the probabilities, that each image subsequence of the at least one image subsequence is classified as each of multiple predetermined characters corresponding to the specified content, to obtain a feature vector corresponding to the each image subsequence; and

concatenating the feature vectors of the at least one image subsequence based on the voice recognition result of the audio corresponding to the image sequence to obtain a concatenating result, where the fusion recognition result includes the concatenating result.

For example, the classification probabilities of each of the at least one image subsequence, such as a probability of being classified as each number from 0 to 9, is obtained through the lipreading processing of each of the at least one image subsequence. Afterwards, the probabilities that each image subsequence is classified into each number from 0 to 9 may be sorted to obtain a 1×10 feature vector of the image subsequence.

Then, a confusion matrix is established based on the feature vector of each of the at least one image subsequence, or based on the feature vectors of a plurality of image subsequences extracted therefrom (for example, the abovementioned feature vectors are randomly extracted according to the length of the numbers in the specified content).

In one example, a 10×10 confusion matrix may be established based on the feature vector of each of the at least one image subsequence. The number of a row or a column where the feature vector corresponding to the image subsequence is located may be determined based on the numerical value in the voice recognition result corresponding to the image subsequence. In some embodiments of the disclosure, if the numerical values in the audio recognition corresponding to the two or more image subsequences are the same, the values of the feature vectors of the two or more image subsequences are added element by element to obtain the elements of the row or column corresponding to the numerical value. Similarly, if the characters in the specified content are letters, a 26×26 confusion matrix may be established, and if the characters in the specified content are Chinese characters, English words or other forms, a corresponding confusion matrix may be established based on a predetermined dictionary. No limitation is made thereto in the embodiments of the present disclosure.

After the confusion matrix is obtained, the confusion matrix may be elongated into a vector. For example, in the above example, the 10×10 confusion matrix is elongated into a 1×100 concatenating vector (i.e., the concatenating result), and the matching degree between the lipreading result and the voice recognition result may be further determined.

According to one or more embodiments of the disclosure, the concatenating result may be a concatenating vector, a concatenating matrix or a data type of other dimensions. The specific implementation of the concatenating is not limited in the embodiments of the present disclosure.

Whether the fusion recognition result matches the voice recognition result may be determined in various manners. In some optional examples, whether the fusion recognition result matches the voice recognition result may be determined through a machine learning algorithm. In some other optional examples, whether the fusion recognition result matches the voice recognition result of the audio may be determined through the second neural network model, for example, the fusion recognition result and the voice recognition result of the audio may be directly input to the second neural network model for processing, and the second neural network model outputs the matching result between the fusion recognition result and the voice recognition result. For another example, the fusion recognition result and/or the voice recognition result of the audio may be subjected to one or more processing, and then input to the second neural network model for processing, and the matching result between the fusion recognition result and the voice recognition result is output. No limitation is made thereto in the embodiments of the present disclosure. In this way, whether the fusion recognition result matches the voice recognition result is determined through the second neural network model, thereby determining whether the anti-spoofing detection passes. By using the powerful learning capability of a deep neural network model, the matching degree between the fusion recognition result and the voice recognition result may be effectively determined, so that the lipreading anti-spoofing detection is implemented according to the matching result between the fusion recognition result and the voice recognition result, thereby improving the accuracy of anti-spoofing detection.

In some possible implementations, the determining of whether the fusion recognition result matches the voice recognition result of the audio corresponding to the image sequence includes:

inputting the fusion recognition result and the voice recognition result to a second neural network model for processing, to obtain a matching probability between the lipreading result and the voice recognition result; and

determining whether the lipreading result matches the voice recognition result based on the matching probability between the lipreading result and the voice recognition result.

For example, the second neural network model may obtain a probability that the lipreading result matches the voice recognition result based on the fusion recognition result and the voice recognition result. In this case, the matching result between the lipreading result and the voice recognition result may be determined based on whether the matching probability obtained by the second neural network model is greater than a predetermined threshold, thereby obtaining an anti-spoofing detection result that spoofing exists or does not exist. For example, in the case that the matching probability output by the second neural network model is greater than or equal to the predetermined threshold, it is determined that the lipreading result matches the voice recognition result, and it is further determined that the image sequence is non-spoofing, i.e., the anti-spoofing detection passes. For another example, in the case that the matching probability output by the second neural network model is less than the predetermined threshold, it is determined that the lipreading result does not match the voice recognition result, and it is further determined that the image sequence is spoofing, i.e., the anti-spoofing detection does not pass. The operation of obtaining the anti-spoofing detection result based on the matching probability may be executed by the second neural network model, or may be executed by other units or apparatuses, which is not limited in the embodiments of the present disclosure.

In some possible implementations, the method according to the embodiments of the present disclosure further includes:

performing voice recognition processing on the audio corresponding to the image sequence to obtain the voice recognition result; and

determining whether the voice recognition result is consistent with the specified content.

The determining of the anti-spoofing detection result based on the matching result between the fusion recognition result and the voice recognition result of the audio includes:

determining, in response to the voice recognition result of the audio corresponding to the image sequence being consistent with the specified content and the lipreading result of the image sequence matching the voice recognition result of the audio, that the anti-spoofing detection result is that the anti-spoofing detection passes.

For example, the audio corresponding to the image sequence may be segmented to obtain a segmentation result of the audio; the segmentation result of the audio includes an audio segment (at least one audio segment) corresponding to each of the at least one character included in the specified content. Each audio segment corresponds to one character in the specified content, such as one number, letter, Chinese character, English word or other symbol, or the like.

In some possible implementations, voice recognition processing may be performed on the at least one audio segment of the audio to obtain the voice recognition result of the audio. The voice recognition manner used is not limited in the present disclosure.

In some possible implementations, it may be first determined whether the voice recognition result is consistent with the specified content, and if it is determined that the voice recognition result is consistent with the specified content, it is determined whether the fusion recognition result matches the voice recognition result. In this case, according to some embodiments of the disclosure, if it is determined that the voice recognition result is inconsistent with the specified content, there is no need to determine whether the fusion recognition result matches the voice recognition result, and the anti-spoofing detection result is directly determined to be that the anti-spoofing detection does not pass.

Alternatively, the determining whether the voice recognition result is consistent with the specified content and the determining whether the fusion recognition result matches the voice recognition result may be simultaneously performed, which is not limited in the embodiments of the present disclosure. The anti-spoofing detection result is determined based on the determination result of whether the audio-based voice recognition result is consistent with the specified content, and the matching result of whether the fusion recognition result matches the voice recognition result of the audio.

In some possible implementations, if the voice recognition result of the audio is consistent with the specified content, and the fusion recognition result matches the voice recognition result of the audio, the anti-spoofing detection result is determined to be that anti-spoofing detection passes. If the voice recognition result of the audio is inconsistent with the specified content, and/or the fusion recognition result does not match the voice recognition result of the audio, the anti-spoofing detection result is determined to be that anti-spoofing detection does not pass.

In the embodiments of the present disclosure, an image sequence and audio are obtained, and voice recognition is performed on the audio to obtain a voice recognition result; lipreading is performed on at least one image subsequence obtained from the image sequence to obtain a lipreading result, and fusion is performed to obtain a fuse recognition result; and whether anti-spoofing detection passes is determined based on whether the voice recognition result is consistent with the specified content and the fusion recognition result matches the voice recognition result. In the embodiments of the present disclosure, anti-spoofing detection is performed by analyzing the image sequence and the corresponding audio when an acquired object reads the specified content, so as to implement the anti-spoofing detection, make the interaction simple, and make it is difficult to simultaneously obtain the image sequence and the corresponding audio without defense, thereby improving the reliability and detection precision of the anti-spoofing detection.

In some possible implementations, the method according to the embodiments of the present disclosure further includes: performing face identity recognition based on a predetermined face image template in response to the anti-spoofing detection result being that the anti-spoofing detection passes. That is, the face identity recognition is performed after the anti-spoofing detection passes. The specific manner of the face identity recognition is not limited in the present disclosure.

In some possible implementations, before obtaining the image sequence in operation 102, the method according to the embodiments of the present disclosure further includes: performing face identity recognition based on the predetermined face image template.

Obtaining at least one image subsequence from the image sequence in operation 102 includes: obtaining the at least one image subsequence from the image sequence in response to a pass of the face identity recognition.

That is, the face identity recognition may be performed first, and the operation of obtaining at least one image subsequence from the image sequence in each embodiment is executed after the face identity recognition passes, so as to perform anti-spoofing detection.

In some possible implementations, the anti-spoofing detection and the identity authentication may be simultaneously performed on the image sequence, which is not limited in the embodiments of the present disclosure.

In some possible implementations, the method according to the embodiments of the present disclosure may further include: in response to the anti-spoofing detection result being that the anti-spoofing detection passes and to a pass of the face identity recognition, performing any one or more of the following operations: an access control release operation, a device unlocking operation, a payment operation, a login operation of an application or device, and a release operation of performing a related operation on the application or device.

In various applications, the anti-spoofing detection may be performed based on the embodiments of the present disclosure, and after the anti-spoofing detection passes, the related operation for indicating the passage of the anti-spoofing detection is executed, thereby improving the security of the applications.

According to the embodiments of the present disclosure, the first neural network model may be used to perform lipreading on the image subsequence, and the second neural network model may be used to determine whether the fusion recognition result matches the voice recognition result, thereby implementing the anti-spoofing detection. Because the learning capability of the neural network models is strong, and supplementary training may be performed in real time to improve the performance, the expandability is strong, update may be quickly performed according to the changes of actual demands so as to quickly deal with a new spoofing situation for anti-spoofing detection, and the accuracy rate of the recognition result may be effectively improved, thereby improving the accuracy of the anti-spoofing detection result.

In the embodiments of the present disclosure, after the anti-spoofing detection result is determined, a corresponding operation may be executed based on the anti-spoofing detection result. For example, if the anti-spoofing detection passes, the related operations for indicating the passage of the anti-spoofing detection may be further selectively performed, such as unlocking, logging in a user account, allowing the transaction, and opening the access control device, or the abovementioned operations may be performed after the face recognition is performed based on the image sequence and the identity authentication passes. For another example, if the anti-spoofing detection does not pass, a prompt message that the anti-spoofing detection does not pass may be selectively output, or the prompt message that the identity authentication fails may be selectively output in the case that the anti-spoofing detection passes but the identity authentication does not pass, which is not limited in the embodiments of the present disclosure.

In the embodiments of the present disclosure, the face, the image sequence or the image subsequence and the corresponding audio may be required to be in the same space-time dimension, and the voice recognition and the lip language anti-spoofing detection are simultaneously performed, thereby improving the anti-spoofing detection effect.

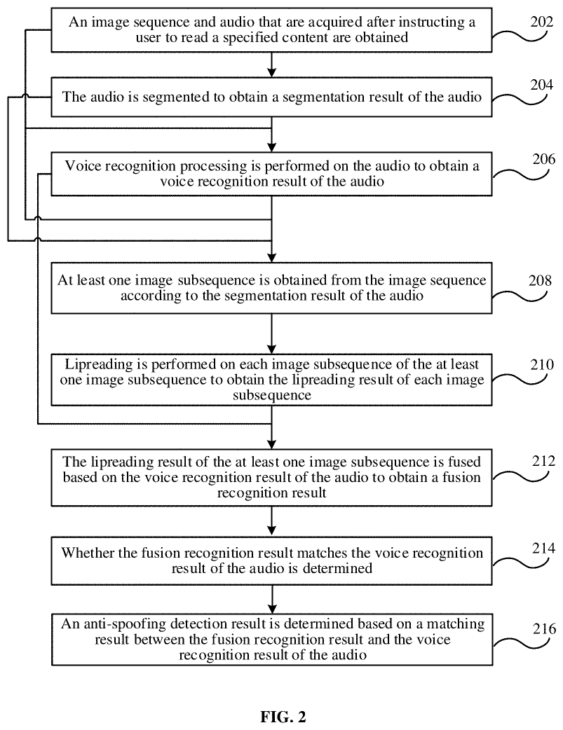

FIG. 2 is another schematic flowchart of the method for anti-spoofing detection according to the embodiments of the present disclosure.

At 202, an image sequence and audio that are acquired after instructing a user to read a specified content are obtained. The image sequence includes multiple images.

In the embodiments of the present disclosure, the image sequence may come from a video that is captured after prompting the user to read the specified content. The audio may be synchronously recorded audio, or may alternatively be a file of an audio type extracted from the captured video. In some embodiments, the specified content includes multiple characters.

Subsequently, operations 204 and 206 are performed on the audio; and operation 208 is performed on the image sequence.

At 204, the audio is segmented to obtain a segmentation result of the audio, where the segmentation result of the audio includes at least one audio segment corresponding to at least one character in the specified content.

At 206: voice recognition processing is performed on the audio to obtain a voice recognition result of the audio, where the voice recognition result of the audio includes the voice recognition result of the at least one audio segment.

At 208: at least one image subsequence is obtained from the image sequence according to the segmentation result of the audio obtained in operation 204.

Each image subsequence includes multiple consecutive images in the image sequence.

In some optional embodiments, the number of the at least one image subsequence is equal to the number of the characters included in the specified content, and moreover, the at least one image subsequence corresponds one-to-one to the at least one character included in the specified content. Each image subsequence corresponds to one character in the specified content.

At 210: lipreading is performed on each of the at least one image subsequence to obtain the lipreading result of each image subsequence.

The lipreading result of each image subsequence may include: a probability that the image subsequence is classified into each of multiple predetermined characters corresponding to the specified content. In some embodiments, the image subsequence may be processed through a first neural network model to obtain the lipreading result of the image subsequence.

At 212: the lipreading result of the at least one image subsequence obtained in operation 206 is fused based on the voice recognition result of the audio obtained in operation 206 to obtain a fusion recognition result.

At 214: whether the fusion recognition result matches the voice recognition result of the audio is determined.

In some embodiments, the fusion recognition result and the voice recognition result may be processed through a second neural network model to obtain a matching result.

At 216: an anti-spoofing detection result is determined based on the matching result between the fusion recognition result and the voice recognition result of the audio.

For example, if the fusion recognition result matches the voice recognition result, the anti-spoofing detection result is determined to be that the anti-spoofing detection passes. Otherwise, if the fusion recognition result does not match the voice recognition result, the anti-spoofing detection result is determined to be that the anti-spoofing detection does not pass.

The fusion recognition result does not match the voice recognition result, for example, it may be that the video remake of a real person and a spoofing identity read the specified content according to the requirement of the system. In this case, the fusion recognition result corresponding to the image sequence obtained from the video captured from the video remark of the real person is inconsistent with the voice recognition result of a corresponding time period, thereby determining that the two do not match, and thus determining that the video is spoofing.

In the embodiments of the present disclosure, an image sequence and audio are obtained, and voice recognition is performed on the audio to obtain a voice recognition result; lipreading is performed on at least one image subsequence obtained from the image sequence to obtain a lipreading result, and fusion is performed to obtain a fuse recognition result; and whether anti-spoofing detection passes is determined based on whether the fusion recognition result matches the voice recognition result. In the embodiments of the present disclosure, anti-spoofing detection is performed by analyzing the image sequence and the corresponding audio when an acquired object reads the specified content, so as to implement the anti-spoofing detection, make the interaction simple, and make it is difficult to simultaneously obtain the image sequence and the corresponding audio without defense, thereby improving the reliability and detection precision of the anti-spoofing detection.

In some of the embodiments of the present disclosure, a confusion matrix (Confusion Matrix) may be established based on the lipreading result and the voice recognition result, and the confusion matrix is converted into feature vectors arranged corresponding to the voice recognition result, and then these feature vectors are input to the second neural network model to obtain a matching result indicating whether the lipreading result matches the voice recognition result.

The confusion matrix is described in detail below based on that the characters in the specified content are numbers.

A probability that each of the at least one image subsequence is classified into each number from 0 to 9 is obtained through lipreading processing of each of the at least one image subsequence. Afterwards, the probabilities that each image subsequence is classified into each number from 0 to 9 may be sorted to obtain a 1×10 feature vector of the image subsequence.

Then, a confusion matrix is established based on the feature vector of each of the at least one image subsequence, or based on the feature vectors of a plurality of image subsequences extracted therefrom (for example, the abovementioned feature vectors are randomly extracted according to the length of the numbers in the specified content).

In one example, a 10×10 confusion matrix may be established based on the feature vector of each of the at least one image subsequence. The number of a row or a column where the feature vector corresponding to the image subsequence is located may be determined based on the numerical value in the voice recognition result corresponding to the image subsequence. In some embodiments of the disclosure, if the numerical values in the audio recognition corresponding to the two or more image subsequences are the same, the values of the feature vectors of the two or more image subsequences are added element by element to obtain the elements of the row or column corresponding to the numerical value. Similarly, if the characters in the specified content are letters, a 26×26 confusion matrix may be established, and if the characters in the specified content are Chinese characters, English words or other forms, a corresponding confusion matrix may be established based on a predetermined dictionary. No limitation is made thereto in the embodiments of the present disclosure.

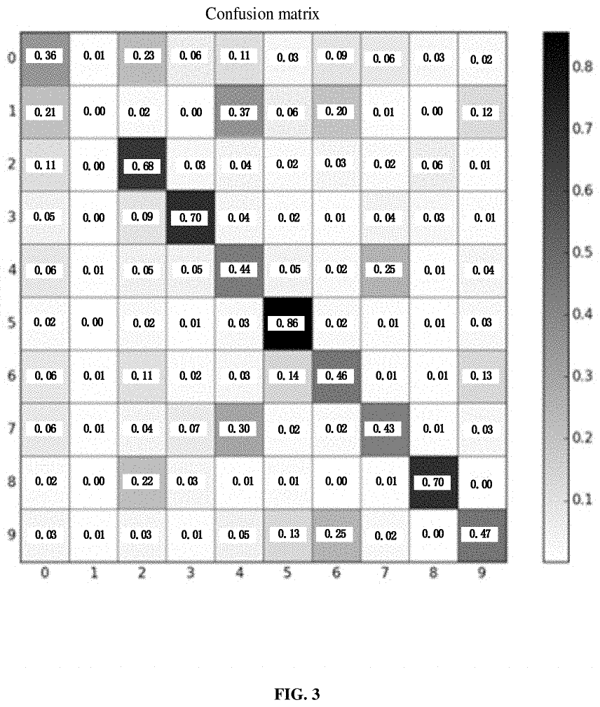

FIG. 3 is a schematic diagram of a confusion matrix and an application example thereof according to the embodiments of this disclosure. As shown in FIG. 3, the element values in each row are obtained based on the lipreading result of the image subsequence corresponding to the audio segment whose voice recognition result is equal to the number of the row. The color bar, on the right side, which changes from light to dark identifies the color representing the probability value that each image subsequence is predicted to be a certain category, and in addition, this correspondence is reflected in the confusion matrix. The darker the color, the greater the probability that the image subsequence corresponding to the horizontal axis is predicted to be the actual label category corresponding to the vertical axis.

After the confusion matrix is obtained, the confusion matrix may be elongated into a vector. For example, in the above example, the 10×10 confusion matrix is elongated into a 1×100 concatenating vector (i.e., the concatenating result) to serve as the input of the second neural network model, and the matching degree between the lipreading result and the voice recognition result is determined by the second neural network model.

In some possible implementations, the second neural network model may obtain a probability that the lipreading result matches the voice recognition result based on the concatenating vector and the voice recognition result. In this case, an anti-spoofing detection result indicating that spoofing exists or does not exist may be obtained based on whether the matching probability obtained by the second neural network model is greater than a predetermined threshold. For example, in the case that the matching probability output by the second neural network model is greater than or equal to the predetermined threshold, it is determined that the image sequence is non-spoofing, i.e., the anti-spoofing detection passes. For another example, in the case that the matching probability output by the second neural network model is less than the predetermined threshold, it is determined that the image sequence is spoofing, i.e., the anti-spoofing detection does not pass. The operation of obtaining the anti-spoofing detection result based on the matching probability may be executed by the second neural network model, or may be executed by other units or apparatuses, which is not limited in the embodiments of the present disclosure.

In a specific application example, taking the specified content being a number sequence 2358 as an example, four image subsequences and four audio segments may be obtained. Each image subsequence corresponds to one audio segment, and the first image subsequence corresponds to a 1×10 feature vector, for example, [0, 0.0293, 0.6623, 0.0348, 0.1162, 0, 0.0984, 0.0228, 0.0362, 0]. The feature vector corresponds to one row in the confusion matrix, and the number of the row is a voice recognition result obtained by performing voice recognition on the first number, for example, equal to 2. In this way, the feature vector corresponding to the first image subsequence is put in the second row of the matrix, and so on, the feature vector corresponding to the second image subsequence is put in the third row of the matrix, the feature vector corresponding to the third image subsequence is put in the fifth row of the matrix, the feature vector corresponding to the fourth image subsequence is put in the eighth row of the matrix, and 0 is supplemented to the unfilled part of the matrix to form a 10×10 matrix. The matrix is elongated to obtain a 1×100 concatenating vector (i.e., the fusion recognition result), and the concatenating vector and the voice recognition result of the audio are input to the second neural network model for processing, that is, the matching result of whether the lipreading result of the image sequence matches the voice recognition result may be obtained.

In the embodiments of the present disclosure, the lipreading is performed on the at least one image subsequence by using the first neural network model, and the probability of possible classification into similar lip morphology is introduced. For each image subsequence, the probability corresponding to each character is obtained. For example, the lip shapes (mouth morphology) of the numbers “0” and “2” are similar, and are easily misidentified in a lipreading part. In the embodiments of the present disclosure, the learning error of a first deep neural network model is considered, the probability of possible classification into similar lip morphology is introduced, and remedy may be conducted to a certain extent when an error occurs in the lipreading result, thereby reducing the influence of the classification precision of the lipreading result on the anti-spoofing detection.

Based on the embodiments of the present disclosure, lip morphology modeling is performed using a deep learning framework to obtain the first neural network model, so that the resolution of the lip morphology is more accurate; moreover, an audio module may be used to perform image sequence segmentation on the segmentation result of the audio, so that the first neural network model may better recognize the content read by the user; in addition, whether the lipreading result matches the voice recognition result is determined based on the voice recognition result of the at least one audio segment and the probability that each of the at least one image subsequence respectively corresponds to each character, and there is a certain fault tolerance to the lipreading result, so that the matching result is more accurate.

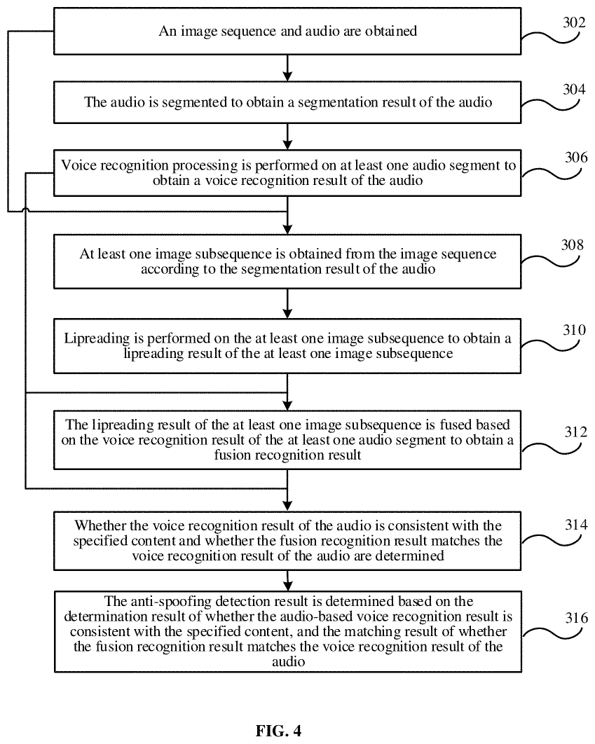

FIG. 4 is another schematic flowchart of the method for anti-spoofing detection according to the embodiments of the present disclosure.

At 302: an image sequence and audio are obtained. The image sequence includes multiple images.

In the embodiments of the present disclosure, the image sequence may come from a video captured on site after prompting the user to read the specified content. The audio may be audio synchronously recorded on site, and may also be an audio type file extracted from the video captured on site.

Subsequently, operations 304 and 306 are performed for the audio; and operation 308 is performed for the image sequence.

At 304: the audio is segmented to obtain a segmentation result of the audio, where the segmentation result of the audio includes at least one audio segment of at least one character in the specified content. Each of the at least one audio segment corresponds to one character in the specified content or one character read/read-out by the user, such as, one number, letter, Chinese character, English word or other symbol, or the like.

At 306: voice recognition processing is performed on the at least one audio segment to obtain a voice recognition result of the audio, which includes the voice recognition result of the at least one audio segment. Then, operations 312 and 314 are executed.

At 308: at least one image subsequence is obtained from the image sequence according to the segmentation result of the audio obtained in operation 304.

Each image subsequence includes at least one image in the image sequence. The number of the at least one image subsequence is equal to the number of the characters included in the specified content, and moreover, the at least one image subsequence corresponds one-to-one to the at least one character included in the specified content. Each image subsequence corresponds to one character in the specified content.

For example, the audio corresponding to the image sequence may be segmented into at least one audio segment, and at least one image subsequence is obtained from the sequence of images based on the at least one audio segment.

At 310: lipreading is performed on the at least one image subsequence, for example, through a first neural network model to obtain a lipreading result of the at least one image subsequence.

At 312: the lipreading result of the at least one image subsequence is fused based on the voice recognition result of the at least one audio segment obtained in operation 306 to obtain a fusion recognition result.

At 314: whether the voice recognition result of the audio is consistent with the specified content and whether the fusion recognition result matches the voice recognition result of the audio are determined.

For example, it may be first determined whether the voice recognition result is consistent with the specified content, and if it is determined that the voice recognition result is consistent with the specified content, it is determined whether the fusion recognition result matches the voice recognition result. In this case, according to some embodiments of the disclosure, if it is determined that the voice recognition result is inconsistent with the specified content, there is no need to determine whether the fusion recognition result matches the voice recognition result, and an anti-spoofing detection result is directly determined to be that the anti-spoofing detection does not pass.

Alternatively, the determining whether the voice recognition result is consistent with the specified content and the determining whether the fusion recognition result matches the voice recognition result may be simultaneously performed, which is not limited in the embodiments of the present disclosure.

At 316: the anti-spoofing detection result is determined based on the determination result of whether the audio-based voice recognition result is consistent with the specified content, and the matching result of whether the fusion recognition result matches the voice recognition result of the audio.

For example, if the voice recognition result of the audio is consistent with the specified content, and the fusion recognition result matches the voice recognition result of the audio, the anti-spoofing detection result is determined to be that anti-spoofing detection passes. If the voice recognition result of the audio is inconsistent with the specified content, and/or the fusion recognition result does not match the voice recognition result of the audio, the anti-spoofing detection result is determined to be that the anti-spoofing detection does not pass.

In the embodiments of the present disclosure, an image sequence and audio are obtained, and voice recognition is performed on the audio to obtain a voice recognition result; lipreading is performed on at least one image subsequence obtained from the image sequence to obtain a lipreading result, and fusion is performed to obtain a fuse recognition result; and whether anti-spoofing detection passes is determined based on whether the voice recognition result is consistent with the specified content and the fusion recognition result matches the voice recognition result. In the embodiments of the present disclosure, anti-spoofing detection is performed by analyzing the image sequence and the corresponding audio when an acquired object reads the specified content, so as to implement the anti-spoofing detection, make the interaction simple, and make it is difficult to simultaneously obtain the image sequence and the corresponding audio without defense, thereby improving the reliability and detection precision of the anti-spoofing detection.

In addition, in the method for anti-spoofing detection according to still another embodiment of the present disclosure, the operation of obtaining an image sequence in each embodiment may be started in response to the receipt of an authentication request sent by the user. Alternatively, the above anti-spoofing detection procedures may be executed in the cast that instructions from other devices are received or other triggering conditions are satisfied. The triggering conditions for anti-spoofing detection are not limited in the embodiments of the present disclosure.

In addition, before the foregoing embodiments of the method for anti-spoofing detection of the present disclosure, the method may further include: an operation of training the first neural network model.

When training the first neural network model, the abovementioned image sequence is specifically a sample image sequence. Accordingly, with respect to the foregoing embodiments, the method for anti-spoofing detection of this embodiment further includes: respectively using the voice recognition result of the at least one audio segment as label content of the corresponding at least one image subsequence; obtaining a difference between a character corresponding to each of the at least one image subsequence obtained by the first neural network model and the corresponding label content; and training the first neural network model based on the difference, i.e., adjusting network model parameters of the first neural network model until predetermined training completion conditions are satisfied, for example, the number of trainings reaches a predetermined number of trainings, and/or a difference between the predicted content of the at least one image subsequence and the corresponding label content is less than a predetermined difference, and the like. The trained first neural network model can implement accurate lipreading on the input video or the image sequence selected from the video based on the method for anti-spoofing detection of the foregoing embodiments of the present disclosure.

Based on the foregoing embodiments of the present disclosure, by performing modeling through the powerful description capability of a deep neural network model and performing training through large-scale sample image sequence data, the features of the object when reading the specified content can be effectively learned and extracted, thereby implementing the lipreading of the video or image.

In addition, before the foregoing embodiments of the method for anti-spoofing detection of the present disclosure, the method may further include: an operation of training the second neural network model.

When training the second neural network model, the lipreading result of the at least one image subsequence in the sample image sequence when the object reads the specified content and the voice recognition result of the at least one audio segment in the corresponding sample audio are used as the input of the second neural network model, a difference between the matching degree between the lipreading result of the at least one image subsequence output by the second neural network model and the voice recognition result of the at least one audio segment and the matching degree tagged for the sample image sequence and the sample audio is obtained by comparison, and the second neural network model is trained based on the difference, that is, the network parameters of the second neural network model are adjusted until the predetermined training completion conditions are satisfied.

Any method for anti-spoofing detection provided by the embodiments of the present disclosure may be executed by any appropriate device having a data processing capability, including, but not limited to, a terminal device, a server, and the like. Alternatively, any method for anti-spoofing detection provided in the embodiments of the present disclosure is executed by a processor, for example, any method for anti-spoofing detection mentioned in the embodiments of the present disclosure is executed by the processor by invoking corresponding instructions stored in a memory. Details are not described below again.

A person skilled in the art may understand that: all or some steps for implementing the foregoing method embodiments are achieved by a program by instructing related hardware; the foregoing program may be stored in a computer readable storage medium; and when the program is executed, the steps including the foregoing method embodiments are executed. Moreover, the foregoing storage medium includes various media capable of storing program codes, such as a ROM, a RAM, a magnetic disk, or an optical disk.

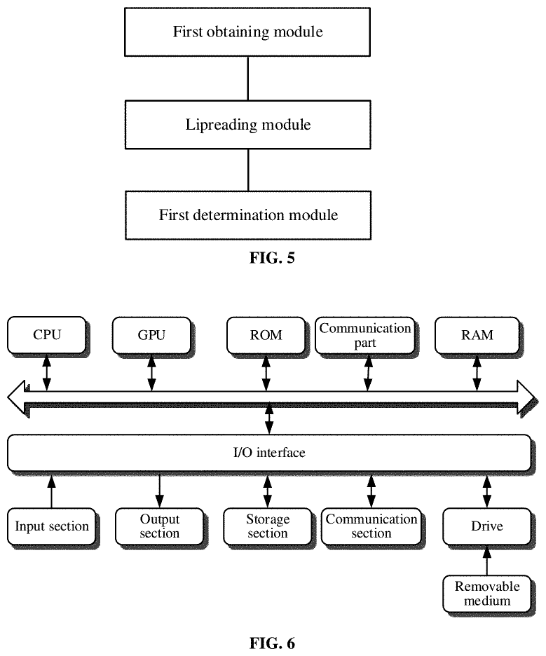

FIG. 5 is a block diagram of an apparatus for anti-spoofing detection according to the embodiments of the present disclosure. The apparatus for anti-spoofing detection of this embodiment may be configured to implement embodiments of the method for anti-spoofing detection as shown in FIGS. 1-4 of the present disclosure. As shown in FIG. 5, the apparatus for anti-spoofing detection of this embodiment includes:

a first obtaining module, configured to obtain at least one image subsequence from an image sequence, where the image sequence is acquired by an image acquisition apparatus after prompting a user to read a specified content, and the image subsequence includes at least one image in the image sequence; a lipreading module, configured to perform lipreading on the at least one image subsequence to obtain a lipreading result of the at least one image subsequence; and a first determination module, configured to determine an anti-spoofing detection result based on the lipreading result of the at least one image subsequence.

In some possible implementations, the first obtaining module is configured to obtain the at least one image subsequence from the image sequence according to a segmentation result of audio corresponding to the image sequence.

In some possible implementations, where the segmentation result of the audio includes: an audio segment corresponding to each of at least one character included in the specified content. The first obtaining module is configured to obtain the image subsequence corresponding to each character from the image sequence according to time information of the audio segment corresponding to each character in the specified content.

In some possible implementations, the time information of the audio segment includes any one or more of: the duration of the audio segment, the start time of the audio segment, and the end time of the audio segment.

In some possible implementations, the apparatus further includes: a second obtaining module, configured to obtain the audio corresponding to the image sequence; and an audio segmentation module, configured to segment the audio to obtain at least one audio segment, where each of the at least one audio segment corresponds to one character in the specified content.

In some possible implementations, the lipreading module is configured to: a first obtaining sub-module, configured to obtain lip region images from at least two target images included in the image subsequence; and a first lipreading submodule, configured to obtain the lipreading result of the image subsequence based on the lip region images of the at least two target images.

In some possible implementations, the first obtaining sub-module is configured to: perform key point detection on the target images to obtain information of face key points, where the information of the face key points includes position information of lip key points; and obtain the lip region images from the target images based on the position information of the lip key points.

In some possible implementations, the apparatus further includes: an alignment module configured to perform alignment processing on the target images to obtain target images subjected to the alignment processing; and a position determination module, configured to determine, based on the alignment processing, position information of the lip key points in the target images subjected to the alignment processing. The first obtaining sub-module is configured to obtain lip region images from the target images subjected to the alignment processing based on the position information of the lip key points in the target images subjected to the alignment processing.

In some possible implementations, the lipreading sub-module is configured to: input the lip region images of the at least two target images to a first neural network model for recognition processing, and output the lipreading result of the image subsequence.

In some possible implementations, the lipreading module includes: a morphology obtaining sub-module, configured to obtain lip morphology information of the at least two target images included in the image subsequence; and a second lipreading submodule, configured to obtain the lipreading result of the image subsequence based on the lip morphology information of the at least two target images.

In some possible implementations, the morphology obtaining sub-module is configured to: determine the lip morphology information of each target image based on a lip region image obtained from each of the at least two target images.

In some possible implementations, the morphology obtaining sub-module is configured to: perform feature extraction processing on the lip region image to obtain a lip morphology feature of the lip region image, where the lip morphology information of the target image includes the lip morphology feature.

In some possible implementations, the apparatus further includes: an image selection module, configured to select the at least two target images from the image subsequence.

In some possible implementations, the image selection module includes: a selection sub-module, configured to select a first image that satisfies a predetermined quality standard from the image subsequence; and a first determination sub-module, configured to determine the first image and at least one second image adjacent to the first image as the target images.

In some possible implementations, the predetermined quality standard includes any one or more of: the image includes a complete lip edge, the lip definition reaches a first condition, and the light brightness of the image reaches a second condition.

In some possible implementations, the at least one second image includes at least one image that is before the first image and adjacent to the first image, and includes at least one image that is after the first image and adjacent to the first image.

In some possible implementations, each of the at least one image subsequence corresponds to one character in the specified content.

In some possible implementations, the characters in the specified content include any one or more of: numbers, English letters, English words, Chinese characters, and symbols.

In some possible implementations, the first determination module includes: a fusion sub-module, configured to fuse the lipreading result of the at least one image subsequence to obtain a fusion recognition result; a second determination sub-module, configured to determine whether the fusion recognition result matches a voice recognition result of the audio corresponding to the image sequence; and a third determination sub-module, configured to determine the anti-spoofing detection result based on a matching result between the fusion recognition result and the voice recognition result of the audio.

In some possible implementations, the fusion sub-module is configured to fuse, based on the voice recognition result of the audio corresponding to the image sequence, the lipreading result of the at least one image subsequence to obtain the fusion recognition result.

In some possible implementations, the fusion sub-module is configured to: sort the probabilities that each image subsequence of the at least one image subsequence is classified as each of multiple predetermined characters corresponding to the specified content to obtain a feature vector corresponding to the each image subsequence; and concatenate the feature vectors of the at least one image subsequence based on the voice recognition result of the audio corresponding to the image sequence to obtain a concatenating result, where the fusion recognition result includes the concatenating result.

In some possible implementations, the second determination sub-module is configured to: input the fusion recognition result and the voice recognition result to a second neural network model for processing, to obtain a matching probability between the lipreading result and the voice recognition result; and determine whether the lipreading result matches the voice recognition result based on the matching probability between the lipreading result and the voice recognition result.

In some possible implementations, the apparatus further includes: a voice recognition module, configured to perform voice recognition processing on the audio corresponding to the image sequence to obtain the voice recognition result; and a fourth determination module, configured to determine whether the voice recognition result is consistent with the specified content. The third determination sub-module is configured to determine, in response to the voice recognition result of the audio corresponding to the image sequence being consistent with the specified content and the lipreading result of the image sequence matching the voice recognition result of the audio, that the anti-spoofing detection result is that the anti-spoofing detection passes.

In some possible implementations, the lipreading result of the image subsequence includes: probabilities that the image subsequence is classified as each of multiple predetermined characters corresponding to the specified content.

In some possible implementations, the apparatus further includes: a generation module, configured to randomly generate the specified content.

In some possible implementations, the apparatus further includes: a first identity recognition module, configured to perform face identity recognition based on a predetermined face image template in response to the anti-spoofing detection result being a pass of the anti-spoofing detection.

In some possible implementations, the apparatus further includes: a second identity recognition module, configured to perform face identity recognition based on a predetermined face image template. The first obtaining module is configured to obtain the at least one image subsequence from the image sequence in response to a pass of the face identity recognition.

In some possible implementations, the apparatus further includes: a control module, configured to, in response to the anti-spoofing detection result being that the anti-spoofing detection passes and to passing of the face identity recognition, perform any one or more of the following operations: an access control release operation, a device unlocking operation, a payment operation, a login operation of an application or device, and a release operation of performing a related operation on the application or device.

In some embodiments, the apparatus for anti-spoofing detection is configured to execute the method for anti-spoofing detection described above. Accordingly, the apparatus for anti-spoofing detection includes modules or units configured to execute the steps and/or procedures of the method for anti-spoofing detection. In order for conciseness, the details are not described here again.

In addition, the embodiments of the present disclosure provide another electronic device, including: a memory, configured to store a computer program; and a processor configured to execute the computer program stored in the memory, where when the computer program is executed, the method for anti-spoofing detection according to any of the foregoing embodiments is implemented.

FIG. 6 is a schematic structural diagram of an electronic device provided by the embodiments of the present disclosure. Referring to FIG. 6 below, a schematic structural diagram of an electronic device, which may be a terminal device or a server, suitable for implementing the embodiments of the present disclosure is shown. As shown in FIG. 6, the electronic device includes one or more processors, a communication part, and the like. The one or more processors are, for example, one or more Central Processing Units (CPUs), and/or one or more Graphic Processing Units (GPUs), and the like. The processor may perform various appropriate actions and processing according to executable instructions stored in a Read-Only Memory (ROM) or executable instructions loaded from a storage section to a Random Access Memory (RAM). The communication part may include, but is not limited to, a network card. The network card may include, but is not limited to, an Infiniband (IB) network card. The processor may communicate with the ROM and/or the RAM, to execute executable instructions. The processor is connected to the communication part via a bus, and communicates with other target devices via the communication part, thereby implementing corresponding operations of any access control method provided in the embodiments of the present disclosure, for example, obtaining at least one image subsequence from an image sequence, where the image sequence is acquired by an image acquisition apparatus after prompting a user to read a specified content, and the image subsequence includes at least one image in the image sequence; performing lipreading on the at least one image subsequence to obtain a lipreading result of the at least one image subsequence; and determining an anti-spoofing detection result based on the lipreading result of the at least one image subsequence.

In addition, the RAM may further store various programs and data required for operations of an apparatus. The CPU, the ROM, and the RAM are connected to each other via the bus. In the presence of the RAM, the ROM is an optional module. The RAM stores executable instructions, or writes the executable instructions into the ROM during running, where the executable instructions cause the processor to execute corresponding operations of any method of this disclosure. An input/output (I/O) interface is also connected to the bus. The communication part may be integrated, or may be configured to have a plurality of sub-modules (for example, a plurality of IB network cards) connected to the bus.

The following components are connected to the I/O interface: an input section including a keyboard, a mouse and the like; an output section including a Cathode-Ray Tube (CRT), a Liquid Crystal Display (LCD), a speaker and the like; the storage section including a hard disk and the like; and a communication section of a network interface card including an LAN card, a modem and the like. The communication part performs communication processing via a network such as the Internet. A drive is also connected to the I/O interface according to requirements. A removable medium such as a magnetic disk, an optical disk, a magneto-optical disk, a semiconductor memory or the like is mounted on the drive according to requirements, so that a computer program read from the removable medium may be installed on the storage section according to requirements.

It should be noted that the architecture shown in FIG. 6 is merely an optional implementation. During specific practice, the number and types of the components in FIG. 6 is selected, decreased, increased, or replaced according to actual requirements. Different functional components are separated or integrated or the like. For example, the GPU and the CPU are separated, or the GPU is integrated on the CPU, and the communication part is separated from or integrated on the CPU or the GPU or the like. These alternative implementations all fall within the scope of protection of this disclosure.

Particularly, a process described above with reference to a flowchart according to the embodiments of the present disclosure may be implemented as a computer software program. For example, the embodiments of this disclosure include a computer program product. The computer program product includes a computer program tangibly included in a machine-readable medium. The computer program includes a program code for performing a method shown in the flowchart. The program code may include instructions for executing the steps of the method for anti-spoofing detection provided by any of the embodiments of the present disclosure. In such an embodiment, the computer program is downloaded and installed from the network through the communication part, and/or is installed from the removable medium. When the computer program is executed by the CPU, the functions defined in the method according to the present disclosure are executed.

In addition, the embodiments of the present disclosure also provide a computer program, including computer instructions. When the computer instructions are run in a processor of a device, the method for anti-spoofing detection according to any of the foregoing embodiments of the present disclosure is implemented.

In addition, the embodiments of the present disclosure also provide a computer-readable storage medium having a computer program stored thereon. When the computer program is executed by a processor, the method for anti-spoofing detection according to any of the foregoing embodiments of the present disclosure is implemented.

In some embodiments, the electronic device or computer program above is configured to execute the method for anti-spoofing detection as described above. In order to conciseness, the details are not described here again.

The embodiments in the specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The methods, apparatuses, and devices in the present disclosure are implemented in many manners. For example, the methods, apparatuses, and devices of the present disclosure may be implemented with software, hardware, firmware, or any combination of software, hardware, and firmware. Unless otherwise specially stated, the foregoing sequences of steps of the methods are merely for description, and are not intended to limit the steps of the methods of the present disclosure. In addition, in some embodiments, the present disclosure may also be implemented as programs recorded in a recording medium. The programs include machine-readable instructions for implementing the methods according to the present disclosure. Therefore, the present disclosure further covers the recording medium storing the programs for executing the methods according to the present disclosure.

The descriptions of the present disclosure are provided for the purpose of examples and description, and are not intended to be exhaustive or limit the present disclosure to the disclosed form. Many modifications and changes are obvious to persons of ordinary skill in the art. The embodiments are selected and described to better describe a principle and an actual application of the present disclosure, and to make a person of ordinary skill in the art understand the present disclosure, so as to design various embodiments with various modifications applicable to particular use.

1. A method for anti-spoofing detection, comprising:
obtaining at least one image subsequence from an image sequence, wherein the image sequence is acquired by an image acquisition apparatus after a user is prompted to read a specified content, and the image subsequence comprises at least one image in the image sequence;
performing lipreading on the at least one image subsequence to obtain a lipreading result of the at least one image subsequence; and
determining an anti-spoofing detection result based on the lipreading result of the at least one image subsequence.

2. The method according to claim 1, wherein obtaining the at least one image subsequence from the image sequence comprises:
obtaining the at least one image subsequence from the image sequence according to a segmentation result of audio corresponding to the image sequence.

3. The method according to claim 2, wherein the segmentation result of the audio comprises: an audio segment corresponding to each of at least one character included in the specified content; and
obtaining the at least one image subsequence from the image sequence according to the segmentation result of the audio corresponding to the image sequence comprises:
obtaining from the image sequence the image subsequence corresponding to each character according to time information of the audio segment corresponding to each character in the specified content.

4. The method according to claim 2, further comprising:
obtaining the audio corresponding to the image sequence; and
segmenting the audio to obtain at least one audio segment, wherein each of the at least one audio segment corresponds to one character in the specified content.

5. The method according to claim 1, wherein performing lipreading on the at least one image subsequence to obtain the lipreading result of the at least one image subsequence comprises:
obtaining lip region images from at least two target images included in the image subsequence; and
obtaining the lipreading result of the image subsequence based on the lip region images of the at least two target images.

6. The method according to claim 5, wherein obtaining lip region images from at least two target images included in the image subsequence comprises:
performing key point detection on the at least two target images to obtain information of face key points, wherein the information of the face key points comprises position information of lip key points; and
obtaining the lip region images from the at least two target images based on the position information of the lip key points.

7. The method according to claim 5, wherein obtaining the lipreading result of the image subsequence based on the lip region images of the at least two target images comprises:
performing recognition processing on the input lip region images of the at least two target images by using a first neural network model to output the lipreading result of the image subsequence.

8. The method according to claim 1, wherein performing lipreading on the at least one image subsequence to obtain the lipreading result of the at least one image subsequence comprises:
obtaining lip morphology information of the at least two target images included in the image subsequence; and
obtaining the lipreading result of the image subsequence based on the lip morphology information of the at least two target images.

9. The method according to claim 8, wherein the obtaining lip morphology information of the at least two target images included in the image subsequence comprises:
performing feature extraction processing on a lip region image obtained from each of the at least two target images to obtain a lip morphology feature of the each target image, wherein the lip morphology information of the target image comprises the lip morphology feature.

10. The method according to claim 5, further comprising:
selecting a first image that satisfies a predetermined quality standard, from the image subsequence; and
determining the first image and at least one second image adjacent to the first image as the at least two target images.

11. The method according to claim 10, wherein the at least one second image comprises at least one image that is before the first image and adjacent to the first image, and comprises at least one image that is after the first image and adjacent to the first image.

12. The method according to claim 1, wherein each of the at least one image subsequence corresponds to one character in the specified content.

13. The method according to claim 1, wherein determining the anti-spoofing detection result based on the lipreading result of the at least one image subsequence comprises:
fusing the lipreading result of the at least one image subsequence to obtain a fusion recognition result;
determining whether the fusion recognition result matches a voice recognition result of the audio corresponding to the image sequence; and
determining the anti-spoofing detection result based on a matching result between the fusion recognition result and the voice recognition result of the audio.

14. The method according to claim 13, wherein fusing the lipreading result of the at least one image subsequence to obtain the fusion recognition result comprises:
fusing, based on the voice recognition result of the audio corresponding to the image sequence, the lipreading result of the at least one image subsequence to obtain the fusion recognition result.

15. The method according to claim 14, wherein fusing, based on the voice recognition result of the audio corresponding to the image sequence, the lipreading result of the at least one image subsequence to obtain the fusion recognition result comprises:
sorting probabilities, that each image subsequence of the at least one image subsequence is classified as each of multiple predetermined characters corresponding to the specified content, to obtain a feature vector corresponding to the each image subsequence; and
concatenating feature vectors of the at least one image subsequence based on the voice recognition result of the audio corresponding to the image sequence to obtain a concatenating result, wherein the fusion recognition result comprises the concatenating result.

16. The method according to claim 13, wherein determining whether the fusion recognition result matches the voice recognition result of the audio corresponding to the image sequence comprises:
obtaining a matching probability between the lipreading result and the voice recognition result based on the fusion recognition result and the voice recognition result by using a second neural network model; and
determining whether the lipreading result matches the voice recognition result based on the matching probability between the lipreading result and the voice recognition result.

17. The method according to claim 13, further comprising:
performing voice recognition processing on the audio corresponding to the image sequence to obtain the voice recognition result; and
determining whether the voice recognition result is consistent with the specified content;
wherein determining the anti-spoofing detection result based on the matching result between the fusion recognition result and the voice recognition result of the audio comprises:
determining, in response to the voice recognition result of the audio corresponding to the image sequence being consistent with the specified content and the lipreading result of the image sequence matching the voice recognition result of the audio, that the anti-spoofing detection result is that the anti-spoofing detection is passed.

18. The method according to claim 1, wherein the lipreading result of the image subsequence comprises: probabilities that the image subsequence is classified as each of multiple predetermined characters corresponding to the specified content.

19. An apparatus for anti-spoofing detection, comprising:
a processor; and
a memory configured to store instructions which, when being executed by the processor, cause the processor to carry out the following:
obtaining at least one image subsequence from an image sequence, wherein the image sequence is acquired by an image acquisition apparatus after a user is prompted to read a specified content, and the image subsequence comprises at least one image in the image sequence;
performing lipreading on the at least one image subsequence to obtain a lipreading result of the at least one image subsequence; and
determining an anti-spoofing detection result based on the lipreading result of the at least one image subsequence.

20. A non-transitory computer-readable storage medium having stored thereon computer programs that, when being executed by a computer, cause the computer to carry out the following:
obtaining at least one image subsequence from an image sequence, wherein the image sequence is acquired by an image acquisition apparatus after a user is prompted to read a specified content, and the image subsequence comprises at least one image in the image sequence;
performing lipreading on the at least one image subsequence to obtain a lipreading result of the at least one image subsequence; and
determining an anti-spoofing detection result based on the lipreading result of the at least one image subsequence.
